(19) United States
(12) Patent Application Publication
(10) Pub. No.: US 2023/0088670 A1
(43) Pub. Date: Mar. 23, 2023

(54) REVERSE COMPILER

(71) Applicant: ROW64, INC., Dillon, CO (US)

(72) Inventor: Michael ISNER, Dillon, CO (US)

(21) Appl. No.: 17/934,550

(22) Filed: Sep. 22, 2022

Related U.S. Application Data
(60) Provisional application No. 63/247,123, filed on Sep. 22, 2021.

(51) Int. Cl. G06F 8/51; G06F 8/41

(52) U.S. Cl. CPC G06F 8/51; G06F 8/425; G06F 8/427

(57) ABSTRACT

Introduced herein are methods and system for translating formulas written in one programming language into functionally equivalent code written in another programming language, or vice versa, by a dynamic compiler in real time. For example, a computer-implemented method according to the disclosed technology includes steps of receiving source code input written in a first programming language from a user device, translating the source code input into functionally equivalent code written in a second programming language, receiving a modification to the source code written in the second programming language from the user device, and dynamically revising the source code input written in the first programming language according to the modification.

### CROSS-REFERENCE TO RELATED APPLICATIONS

The present application claims priority to U.S. Provisional Application No. 63/247,123, filed Sep. 22, 2021, the disclosure of which is hereby incorporated by reference in its entirety.

### TECHNICAL FIELD

This disclosure relates to a dynamic compiler that translates formulas, scripts, and code of one programming language into another programming language, or vice versa, in real-time, and provides a user interface for a user.

### BACKGROUND

The greater the complexity of a programming language, the more challenging and time-consuming it can be to learn and code in the programming languages. However, complex programming languages tend to provide broader functionality compared to simpler or more restrictive programming languages. Tools that enable use of the functionality of complex programming languages without requiring the ability to code in these languages are desirable.

### BRIEF DESCRIPTION OF THE DRAWINGS

FIG. 1 is an exemplary user interface of the reverse compiler system.

FIG. 2 is an exemplary user interface of the reverse compiler system.

FIG. 3 is an exemplary translation between two languages provided by the reverse compiler system.

FIG. 4 is an illustration of an exemplary abstract tree generated by the reverse compiler system.

FIGS. 5A-5B provide exemplary mappings between arguments determined by the reverse compiler system.

FIGS. 6A-6B provide exemplary translations of code segments by the reverse compiler system.

FIGS. 7A-7B provides exemplary translations of code segments by the reverse compiler system.

FIGS. 8A-8B provides exemplary translations of code segments by the reverse compiler system.

FIG. 9 is a flowchart illustrating a method performed by the reverse compiler system.

FIG. 10 provides an exemplary modification processed by the reverse compiler system.

FIG. 11 provides an exemplary modification processed by the reverse compiler system.

FIG. 12 provides an exemplary mapping of blank lines performed by the reverse compiler system.

FIGS. 13A-13C provide an exemplary remapping performed by the reverse compiler system.

FIG. 14 provides an exemplary mapping of a deletion processed by the reverse compiler system.

FIG. 15 is a block diagram illustrating a computer operable to implement the disclosed technology according to some embodiments of the present disclosure.

### DETAILED DESCRIPTION

The reverse compiler system provides an integrated development environment (IDE) that enables real-time translation to and from programs written in two programming languages. In some cases, the two languages vary in complexity or restrictiveness. A user may prefer to use a simpler programming language for various reasons, such as to save time in the coding process or not knowing how to code in a complex programming language. However, the user may nonetheless require the functionality of the complex programming language. For example, the coding task may be part of a broader project that can integrate modules programmed in the more complex programming language, but not the simpler programming language. Finding or hiring someone to complete the coding task in the complex programming language is cumbersome, costly, and time-consuming. In some embodiments, the reverse compiler system can also be used as an educational tool for learning various programming languages.

An exemplary reverse compiler system can translate between first code written in a first programming language (e.g., spreadsheet formulas written in a spreadsheet programming language) and second code written in a second programming language (e.g., Python code written in the Python programming language). For example, as the user inputs a spreadsheet formula with one or more arguments (input values into the formula) into a graphical user interface, the reverse compiler system may translate the entered spreadsheet formula and its arguments into functionally equivalent Python code. For example, the reverse compiler system may map the entered spreadsheet formula into a corresponding function(s) in Python code. The reverse compiler system may also determine the arguments entered with the spreadsheet formula, and may provide the arguments in the appropriate configuration to the corresponding Python function(s). The reverse compiler system may display the generated Python code and any output from running the Python code (e.g., a table of calculated values, a scientific chart or graph, data output, data visualization, images, media, etc.) in the graphical user interface. As the user edits code written in the first programming language, such as the spreadsheet formula or its arguments, in the user interface, the reverse compiler system may again translate the revised first code and its arguments into functionally equivalent second code (e.g., Python code). The reverse compiler system may display the generated second code corresponding to the edited first code or arguments and any output from running the updated second code in the graphical user interface.

The exemplary reverse compiler system is also able to translate from code written in the second programming language into code written in the first programming language. For example, the reverse compiler system may translate Python code into code describing spreadsheet formulas using a similar process as described above. For example, as the user inputs Python code into the graphical user interface, the reverse compiler system may translate the entered Python code into a functionally equivalent spreadsheet program. For example, the reverse compiler system maps the entered Python code into a corresponding spreadsheet formula(s). The reverse compiler may also determine the arguments entered with any functions in the Python code and may provide the arguments in the appropriate configuration to the corresponding spreadsheet formula(s) (or for other programming languages). The reverse compiler system may display the generated spreadsheet program and any output from running the spreadsheet program (e.g., a table of calculated values, a scientific chart or graph, data output, data visualization, images, media, etc.) in the graphical user interface. As the user edits code written in the second programming language (e.g., the Python code) in the user interface, the reverse compiler system again may translate the revised code (e.g., the revised Python code) into a functionally equivalent code in the first programming language (e.g., spreadsheet program). The reverse compiler system may display the generated spreadsheet program corresponding to the edited Python code or arguments and any output from running the updated spreadsheet program in the graphical user interface.

While the above example and other examples described herein discuss translations to and from spreadsheet programs and Python code, embodiments are not so limited. The reverse compiler system can translate between other programming languages as well.

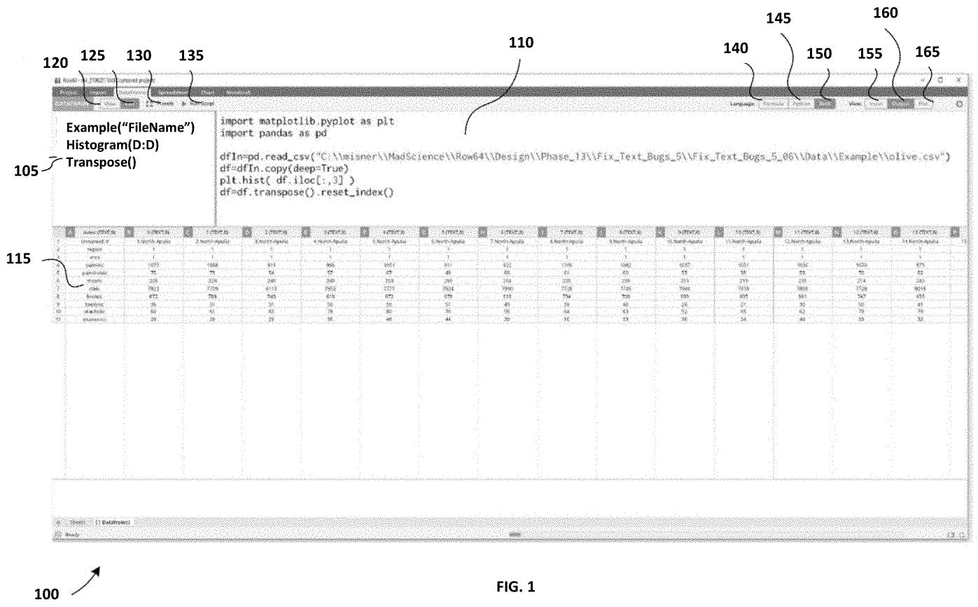

FIG. 1 is an exemplary user interface 100 of a reverse compiler system. In some embodiments, User interface 100 may include a first area 105 for displaying first code (e.g., a spreadsheet program) and a second area 120 for displaying second code (e.g., Python code). In some embodiments, both the first area 105 and the second area 110 are source code editors such that a user can edit code written in either of the text boxes. User interface 100 may include a third area 115 for displaying an output resulting from running the generated code. User interface 100 may include other input elements, such as buttons 120 and 125 for toggling between “View” and “Edit” modes, a “Presets” button 130 for opening a menu(s) for selecting preconfigured formulas or functions to input automatically into the text boxes, a “Run Script” button 135 for running the code displayed in a text box, buttons 140, 145, and 150 for selecting the language to make editable, and buttons 155, 160, and 165 for selecting an “Input, “Output” or “Plot” mode.

In some embodiments, a user can edit (e.g., types or enters using preset menu) the source code editor for the spreadsheet program in user interface 100 while in “Input” mode. In an exemplary embodiment as shown by user interface 100, the user enters, into the first area 105, a spreadsheet program containing three lines of code for reading in a file, plotting a histogram based on a portion of data in the file, and transposing data from the file. In some embodiments, the user clicks the “Run Script” button 135, which can cause the reverse compiler system to generate the functionally equivalent Python code. User interface 100 may display the generated Python code in the second area 110 (i.e., the source code editor for the Python code). User interface 100 also may display the transposed data from the file (“olive.csv”) in the third area 115. The user can toggle between the “Input, “Output” or “Plot” modes to revise the code in the editable text boxes, view the transpose data, or view the histogram, respectively. As described above, the reverse compiler system may perform a similar process to translate Python code into a spreadsheet program when the user inputs or revises source code in the Python source code editor, or when translating between other programming languages.

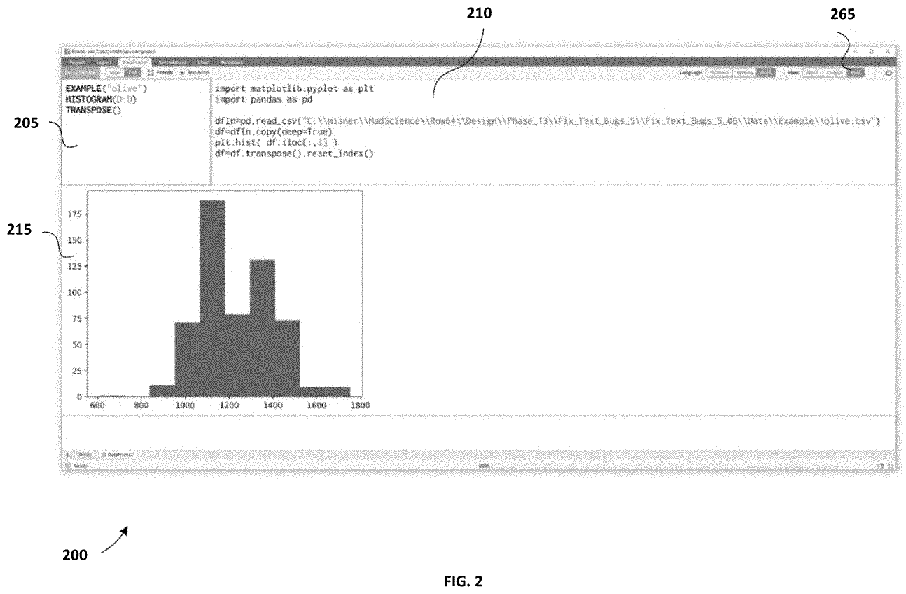

FIG. 2 is an exemplary user interface 200 of the reverse compiler system. User interface 200 may include similar elements to those described with respect to FIG. 1. For example, user interface 200 may include the first area 105 for displaying the spreadsheet source code editor, the second area 110 for displaying the Python source code editor, and the third area 115 for displaying an output resulting from running the generated code. However, user interface 200 may show that the user has selected “Plot” mode by selecting the “Plot” button 165. Thus, user interface 200 may display a histogram generated by the spreadsheet program or Python code in the third area 115.

It is understood that user interfaces 100 and 200 are exemplary and not limiting. The reverse compiler system can implement any suitable user interface including a different configuration of user interface elements compared to those shown in FIG. 1 and FIG. 2. In some embodiments, the “output” and “plot” modes are combined, such that the transposed data and the histogram are viewable at the same time. In some embodiments, the output and/or plot can be displayed in pop-up windows. Different types of user interface elements may be provided other than those shown in user interfaces 100 and 200, such as checkboxes, radio buttons, dropdown lists, dropdown buttons, or list boxes. In some embodiments, the reverse compiler system accepts keyboard shortcuts for entering preset formulas or functions, as well as for navigating the user interface (e.g., toggling between buttons).

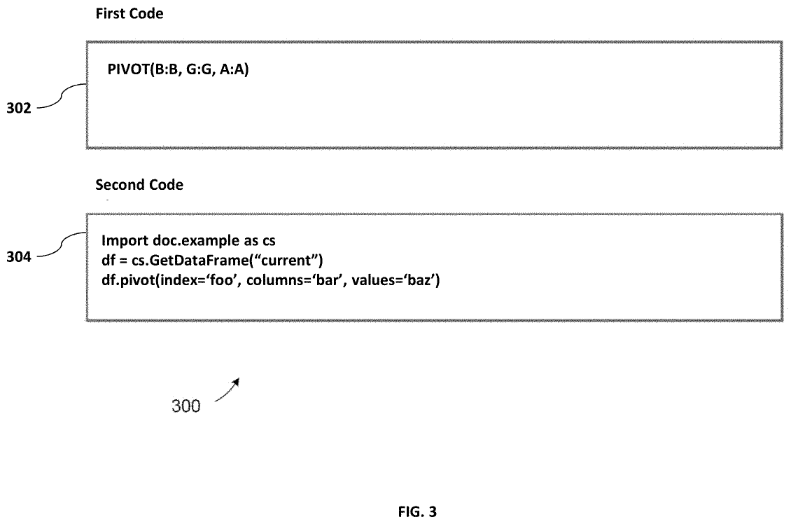

Not all embodiments involve a plot, histogram, or similar to be output by the reverse compiler system. For example, FIG. 3 is an exemplary translation 300 between a spreadsheet formula and Python code that involves manipulation of data.

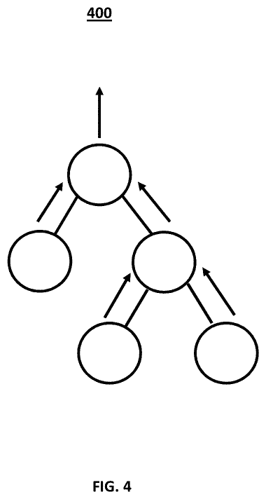

In addition to supplementary functionalities described herein, the reverse compiler system may provide functionalities provided by an integrated development environment (IDE). In some embodiments, the reverse compiler system provides an interactive graphical user interface with source code editors, debugging tools, build automation tools, and compiling capabilities. In some embodiments, the reverse compiler system performs operations typically performed by compilers, including but not limited to lexical analysis, parsing (e.g., syntax analysis), semantic analysis, and code generation. During lexical analysis, the reverse compiler system uses tokenization to convert source code input from its source code editors into a list of tokens. In some cases, the tokenization process splits the string of source code into smaller units with assigned meanings (e.g., separator, operator, keyword, literal, identifier, etc.). Following the tokenization process, the reverse compiler system can perform a parsing analysis during which the information produced during tokenization can be loaded into data structures for general use and compiling. In some embodiments, parsing involves transforming the list of tokens into an abstract syntax tree to represent the structure of the source code program. FIG. 4 shows an illustration of an exemplary abstract tree 400 generated by the reverse compiler system. In some embodiments, a parser performs both lexical analysis and syntactic analysis.

When the reverse compiler system receives source code input in a first programming language from a user, the reverse compiler system may parse the input. Based on the tokens indicating the token value and assigned meanings, the reverse compiler system can determine which code segments correspond to a formula or function (e.g., operator or keyword) and which characters correspond to arguments (e.g., literal). For each of the code segments of the input source code written in a first programming language, the reverse compiler system determines functionally equivalent code segments written in a second programming language. In some embodiments, the reverse compiler system makes the determination based on its stored preconfigured mapping that indicates corresponding formulas, functions, operators, and/or arguments between the first and second programming languages (e.g., Python and spreadsheet formulas). Some corresponding formulas, functions, operators, arguments may be the same across the two programming languages. In some embodiments, the mapping includes information for any components regardless of whether they are the same or different across the two programming languages. The mapping may be stored using any suitable data structure (e.g., lookup table, etc.). In some cases, the reverse compiler system may store multiple mappings to enable translations between multiple combinations of languages.

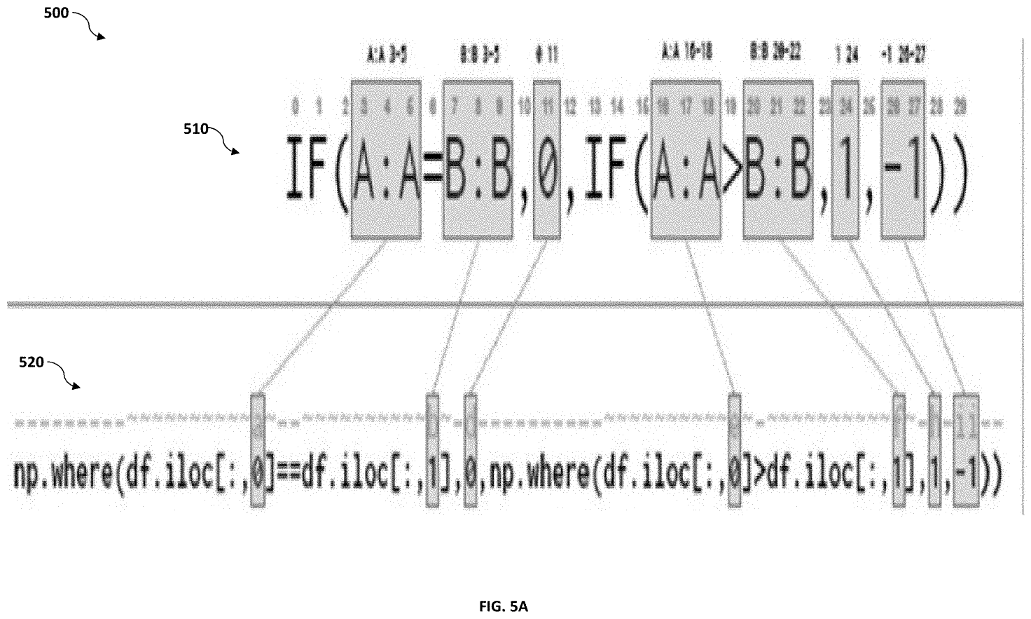

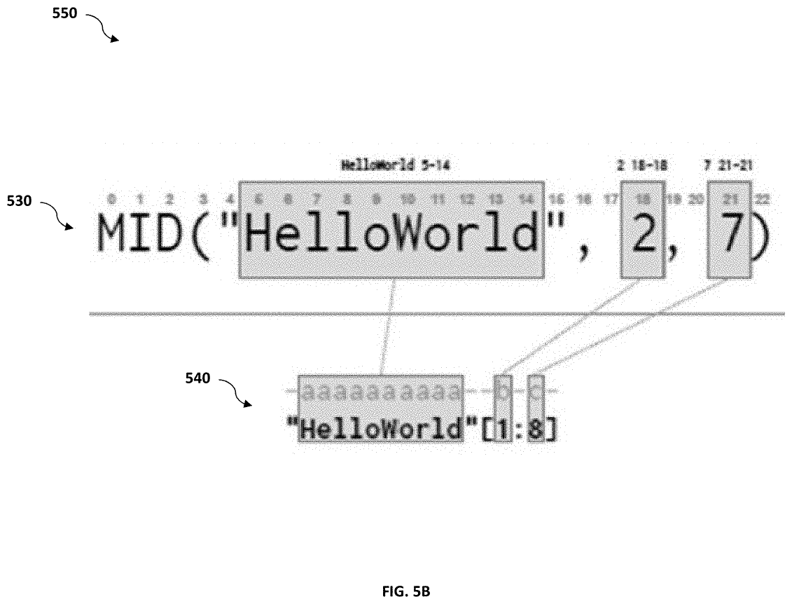

FIGS. 5A-5B provides exemplary mappings 500 and 550 between arguments determined by the reverse compiler system. For example, FIG. 5A provides a first mapping 500 between spreadsheet formula 510 and Python code 520. As another example, FIG. 5B provides a second mapping 550 between spreadsheet formula 530 and Python code 540.

Spreadsheet formula 510 has seven arguments (highlighted). The arguments “A:A” and “B:B” indicate columns A and B, respectively, in a spreadsheet. The arguments “0,” “1,” and “−1” indicate values to output depending on the result of comparison performed on columns A and B. Python code 520 is functionally equivalent to spreadsheet formula 510. In Python, columns are expressed as column number starting at 0, so columns A and B from formula 510 correspond to columns “0” and “1” in Python code 520. The output values “0,” “1,” and “−1” are expressed in the same way in Python, so the values of these arguments remain the same.

In some embodiments, the reverse compiler system may determine the corresponding arguments based on a stored mapping as described above. The reverse compiler system can look up the arguments provided in the source code input written in a first programming language and determines the corresponding argument in the second programming language. If, for example, translating from spreadsheet formulas to Python, the reverse compiler system can look up arguments provided in spreadsheet formula 510. In this case, the reverse compiler system may find that the stored mapping associates columns “A:A” and “B:B” in the spreadsheet formula to columns “0” and “1” in Python, respectively. The mapping can further associate that numerical values “0,” “1,” and “−1” correspond to numerical values “0,” “1,” and “−1” in Python, respectively. The reverse compiler system may perform a similar analysis based on the stored mapping to determine Python functions and operators corresponding to those in spreadsheet formula 510. The reverse compiler system may insert the corresponding Python arguments into the appropriate locations in Python code 520.

As seen in FIG. 5B, spreadsheet formula 530 has three arguments (highlighted). As an example, the argument “HelloWorld” is a string from which certain characters are to be extracted. The arguments “2” and “7” indicate the starting location of the first character to extract from the string and the number of characters to extract, respectively. The string arguments remain the same value in Python code, while the numeric arguments are transformed to start and end indices for extracting the corresponding portion of the string. If translating from spreadsheet formulas to Python, the reverse compiler system can look up arguments provided in spreadsheet formula 530. In this case, the reverse compiler system finds that the stored mapping associates start index “2” and end index “7” in spreadsheet formula 530 to index “1” and end index “7” in Python formula 540, respectively. The reverse compiler system inserts the corresponding Python arguments into the appropriate locations in Python code 540.

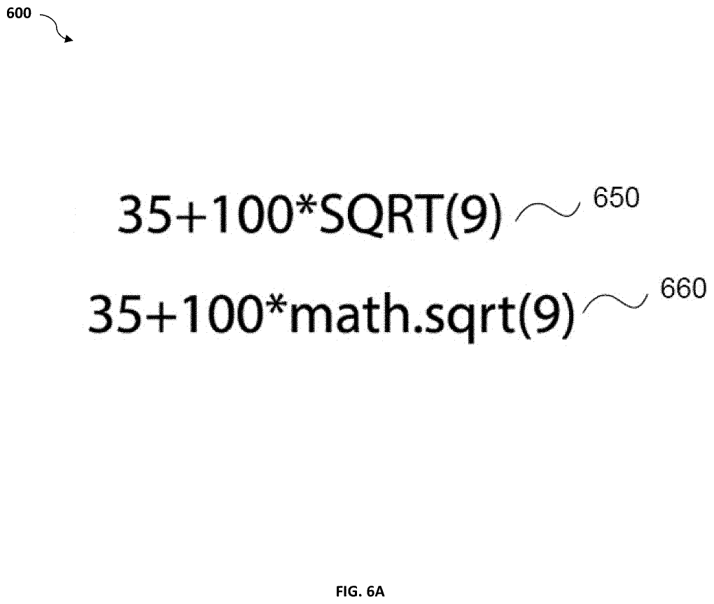

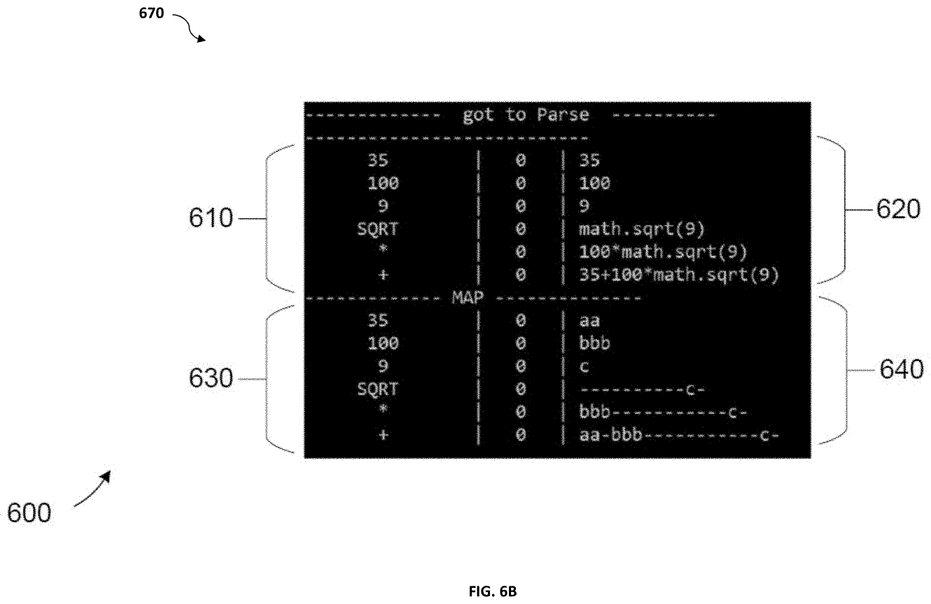

FIGS. 6A-8B provide exemplary translations of code segments by the reverse compiler system. The reverse compiler system can parse the received source code written in a first programming language and splits the source code into code segments as describe above. Each segment is an argument or function/operator that accepts arguments. The reverse compiler system may translate each code segment into functionally equivalent code written in a second programming language. The reverse compiler system may also generate a mapping that indicates the positions (e.g., byte locations) at which arguments translated from the first programming language into the second programming language are to be inserted into the translated code segments.

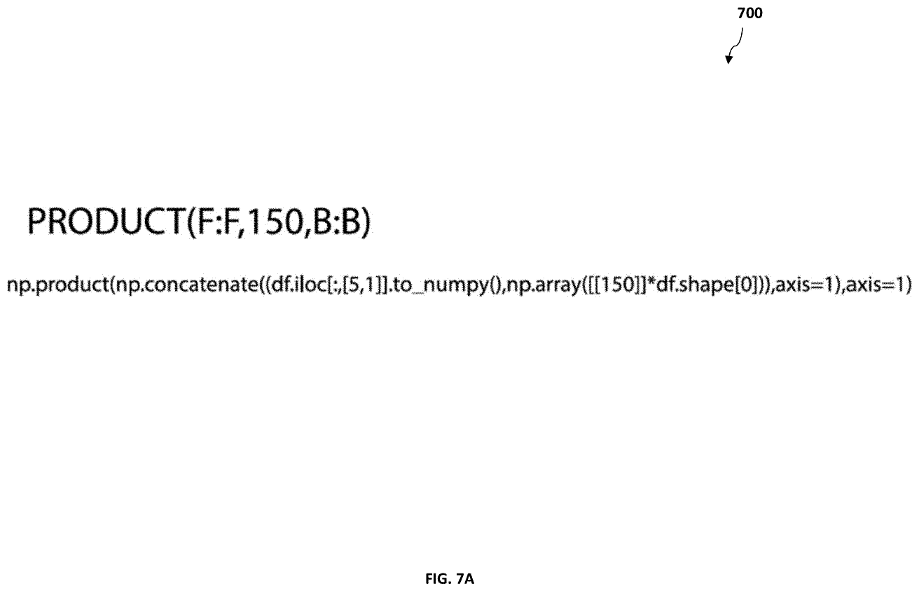

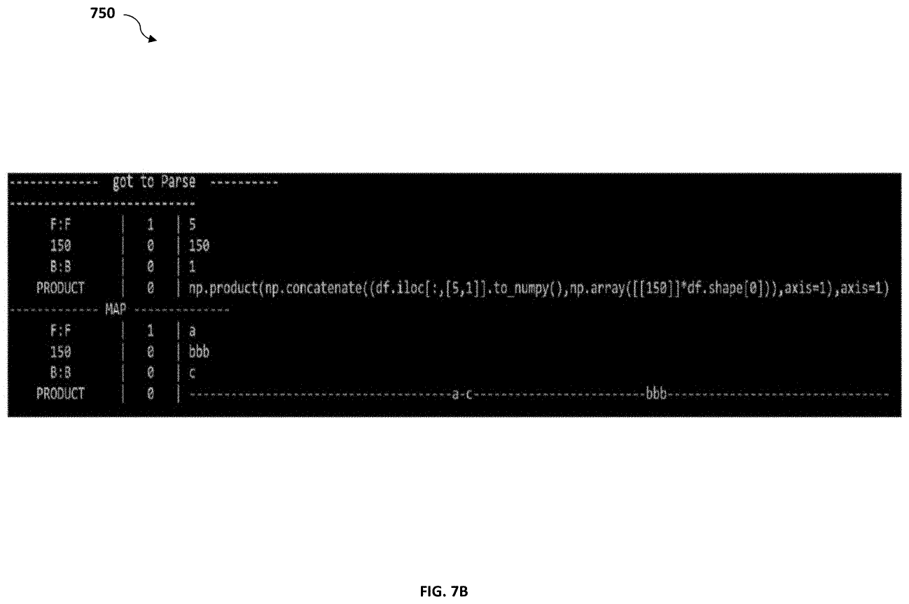

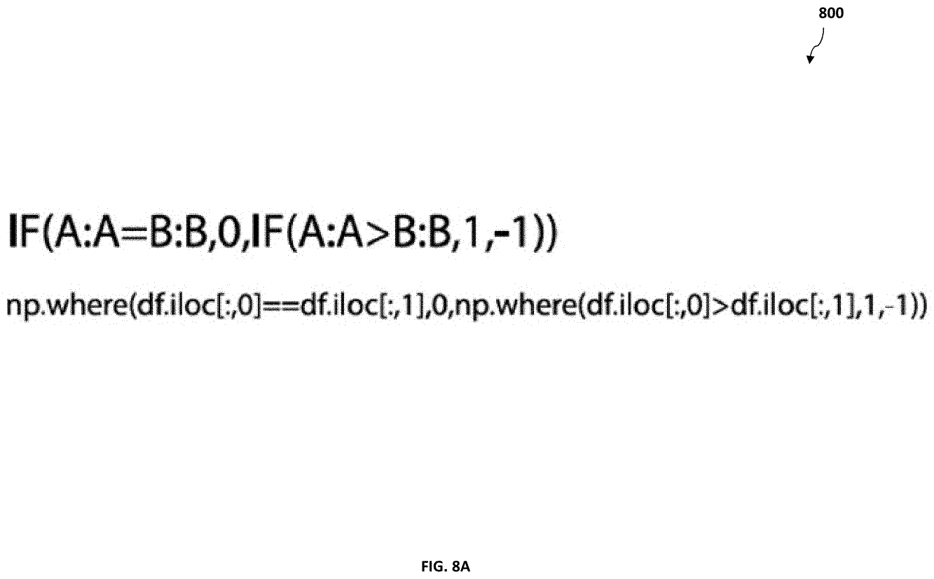

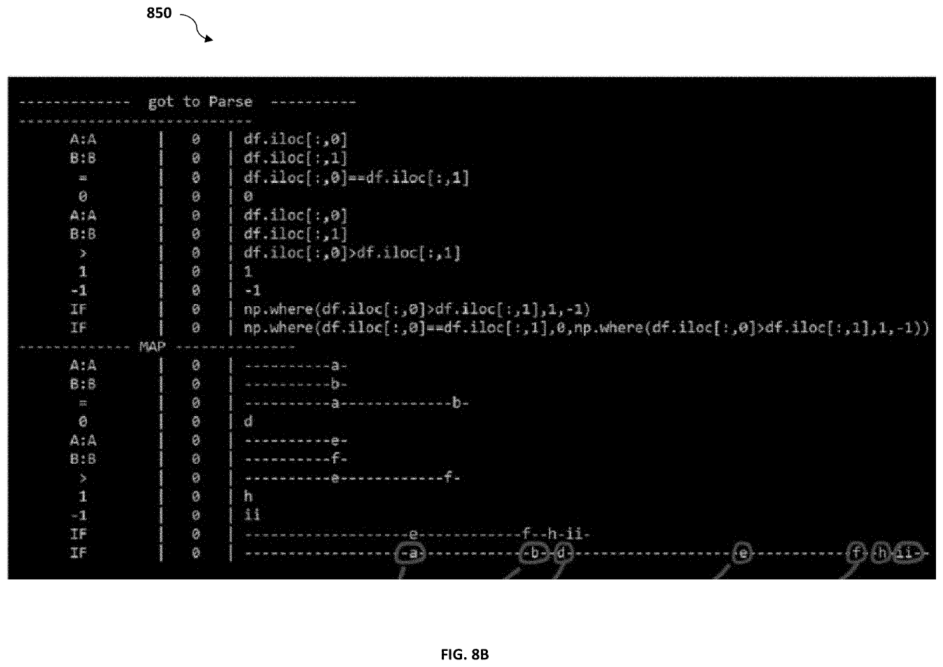

FIGS. 6A-6B provide translations 600 of code segments by the reverse compiler system. In some embodiments, the reverse compiler system receives spreadsheet formula 650 input by a user. The reverse compiler system may parse the spreadsheet formula 650 and split it into code segments as shown by code segments 610 of FIG. 6B. Code segments 610 include the arguments, which are “35,” “100,” “9,” as well as the functions/operators, which are “SQRT,” “*,” and “+.” The reverse compiler may use the stored mapping between spreadsheet and Python formulas, functions, operators, and arguments as described above to determine Python code corresponding to code segments 610. The reverse compiler system can store the resulting code segments 620 and their associations to respective code segments 610. In some embodiments, the reverse compiler system may also generate a mapping 640 that indicates the positions (e.g., byte locations) at which arguments translated from spreadsheet formula 650 into Python code are to be inserted into translated code segments 620. The resulting translated Python code 660 is functionally equivalent to spreadsheet formula 650. Translations 700 and 750 of FIGS. 7A-7B and translations 800 and 850 of FIGS. 8A-8B relate to examples of different spreadsheet formulas and Python code, but the involved parsing and mapping steps are similar to those described with respect to FIGS. 6A-6B.

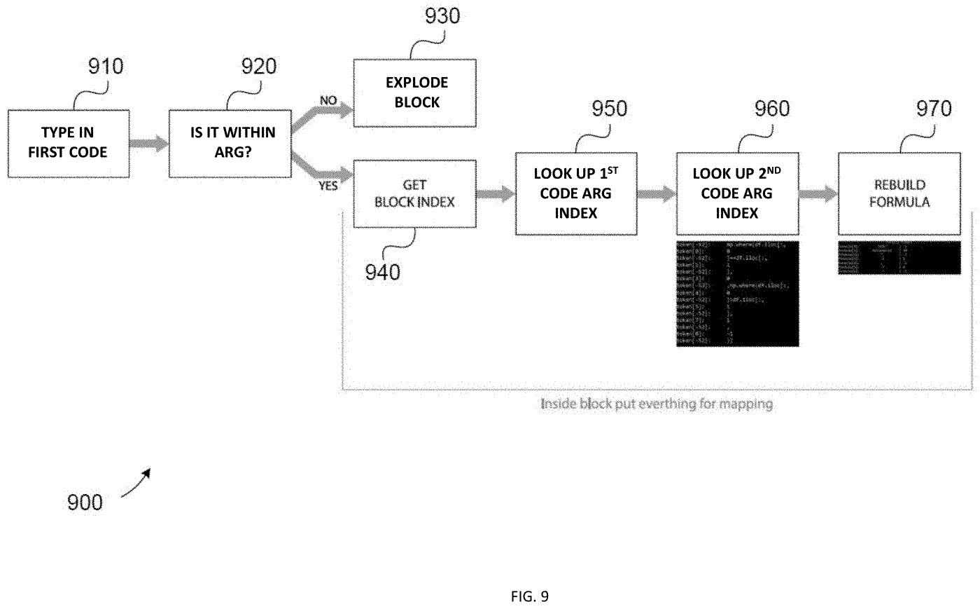

FIG. 9 is a flowchart 900 illustrating a method performed by the reverse compiler system. Flowchart 900 indicates steps involved in dynamically translating source code that is modified by a user. While flowchart 900 is described with respect to an exemplary translation of Python code input by a user into a spreadsheet program, it is understood that a similar method can be used for translation of a spreadsheet program into Python code, or translation between other pairs of languages. A general description is first provided below before a depiction of the method with respect to elements from FIGS. 5A-5B.

In some embodiments, the reverse compiler system has already performed a previous translation between a spreadsheet program and Python code. Thus, the spreadsheet source code editor and the Python source code editor of the reverse compiler system's user interface may display functionally equivalent spreadsheet source code and Python source code, respectively. As a result of this previous translation, the reverse compiler system has stored mapping information indicating associations between corresponding spreadsheet code segments and Python code segments of the source code input by the user, as well as argument mapping information indicating arguments and positions (e.g., byte locations) in which arguments belong in the source code. Flowchart 900 depicts the steps that the reverse compiler system performs when a user seeks an updated translation by modifying the source code in the reverse compiler system's source code editor.

At step 910, the reverse compiler system may receive source code input by a user. For example, the user may edit first code written in a first programming language into a corresponding source code editor for the first programming language (e.g., Python code in the Python source code editor), such as that shown in the user interfaces of FIGS. 1-2. The user can edit the source code using any suitable user device (e.g., laptop, computer, tablet device, etc.). In some embodiments, upon determining that the user edited the first source code, the reverse compiler system may initiate a translation process. In some embodiments, the user clicks a button (e.g., “Run Script”), which notifies the reverse compiler system to initiate the translation process. In some embodiments, the reverse compiler program can automatically initiate a translation process upon detecting that the user has modified source code input in the user interface.

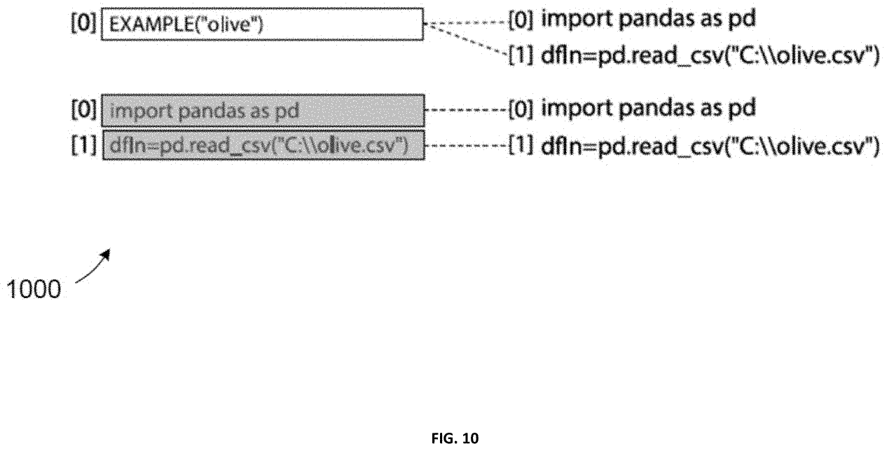

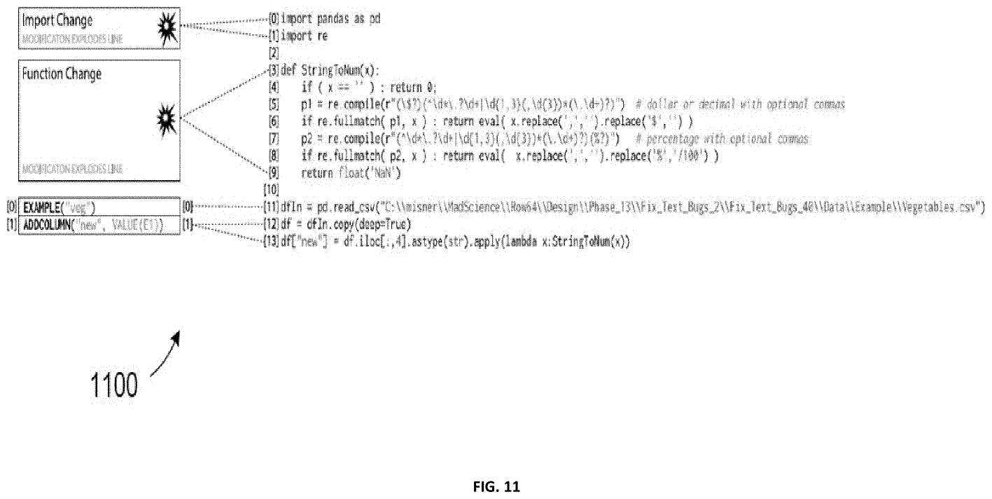

At step 920, the reverse compiler system may determine which portion of the source code was modified. Whether the modified portion is within an argument affects the subsequent steps performed by the reverse compiler system. If the modification is within an argument, the reverse compiler system proceeds to step 940 to revise the translation with the updated argument. If the modification involves code other than an argument (e.g., as shown in exemplary modification 1000 of FIG. 10 or modification 1100 of FIG. 11, described further below), the reverse compiler system proceeds to step 930 to retranslate the affected block of code.

At step 930, the reverse compiler system may retranslate the block of code affected by the user's source code modification. In some embodiments, retranslating involves performing the parsing and mapping steps described above (e.g., with respect to FIGS. 5A-8B) again but with the modified source code.

FIG. 10 shows an exemplary modification 1000 to source code other than an argument processed by the reverse compiler system. For example, FIG. 10 includes modification 1000, which involve adding a line of code including a function, such as at line 0 of the spreadsheet code (EXAMPLE(“olive”)), which can modify more than simply an argument. Thus, the reverse compiler system may translate the function and its arguments into Python code lines 0 and 1 of modification 1000.

FIG. 11 shows an exemplary modification 1100 to source code other than an argument processed by the reverse compiler system. Modifications to helper functions, import statements, from statements, etc. are modifications other than to arguments, which causes the reverse compiler system to retranslate affected blocks of code. For example, if a user modifies the StringToNum( ) function at lines 3 through 9 of the Python code in the Python source code editor, the reverse compiler system determines which blocks of corresponding spreadsheet source code displayed in the spreadsheet source code editor are affected. The reverse compiler system determines that the StringToNum( ) function is called at line 13 of the Python code, which corresponds to line 1 of the spreadsheet code. Accordingly, the reverse compiler system determines that the formula at line 1 of the spreadsheet code is to be retranslated and replaced as appropriate based on the modified Python code.

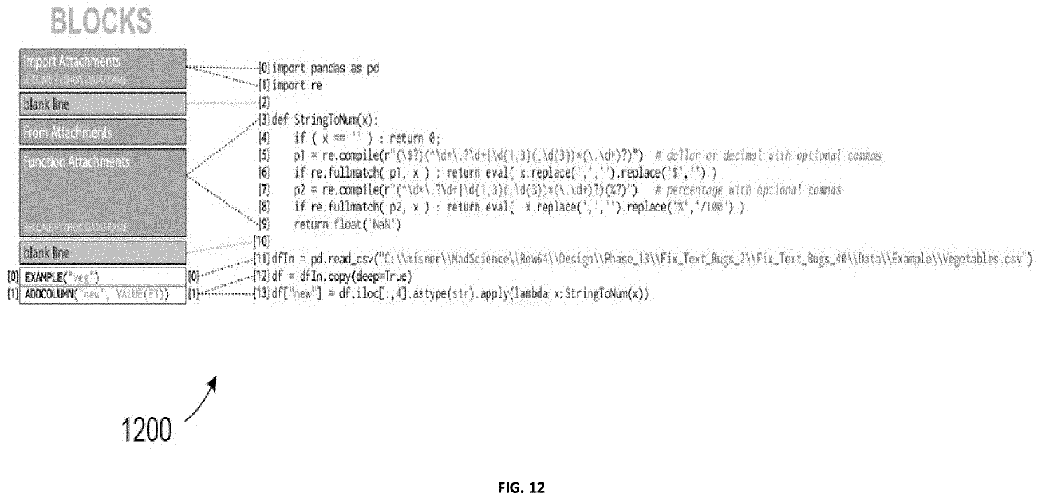

At step 940, if the modification only involves an argument, the reverse compiler system may determine which block of the spreadsheet program is affected by the Python source code modification. In some embodiments, if the source code is a spreadsheet program, each block of the spreadsheet program corresponds to a line of code in the spreadsheet program. Other suitable ways of separating the source code into blocks can be implemented as long as the blocks are separately identifiable. In some embodiments, in other programming languages, such as Python code, the source code may be split into blocks corresponding to import attachments, from statements, function attachments, and lines of code corresponding to spreadsheet formulas. FIG. 12 depicts exemplary blocks 1200 for spreadsheet code and Python code.

In some embodiments, the reverse compiler system may store information to track what the source code corresponds to for each block and may use the stored information to determination the affected block. In some embodiments, the information identifies the start and end of each block (e.g., by line numbers, index, source code text, etc.). Taking the example of FIG. 12, the reverse compiler system may store information indicating that “Block 0” of the spreadsheet program (“EXAMPLE(“veg“)”) corresponds to line 11 of the Python code, and “Block 1” of the spreadsheet program (“ADDCOLUMN(“new“, VALUE(E1)”) corresponds to lines 12 and 13 of the Python code. If the user edits line 13 of the Python code, for example, the reverse compiler system may determine the affected spreadsheet block in “Block 1.”

At step 950, the reverse compiler system may determine which argument was modified in the first code (e.g., the Python code). The reverse compiler system can make this determination based on stored argument mapping information produced from parsing the first code (e.g., Python code). In some embodiments, the argument mapping information identifies each argument by an index (e.g., third code segment corresponding to an argument provided in the source code) and indicates a position (e.g., byte location) within the first code (e.g., Python code) to which the argument maps.

At step 960, the reverse compiler system also can determine the argument in the identified second code block (e.g., spreadsheet block) to which the first code (e.g., Python code) argument identified in step 950 corresponds. The reverse compiler system can make this determination based on stored mapping information indicating associations between code segments of the second code and the first code (e.g., spreadsheet program and Python code). Based on the stored information, the reverse compiler system may identify the code segment of the second code block (e.g., spreadsheet program block) that maps to the modified first code (e.g., Python) argument identified in step 950.

At step 970, the reverse compiler system may revise the identified argument in the second code (e.g., the spreadsheet formula) block to match the value of the modified first code (e.g., Python) argument and rebuilds the updated second code (e.g., spreadsheet program).

A depiction of the method described in flowchart 900 is described with respect to elements from FIGS. 5A-5B. In an exemplary case, the reverse compiler system has already translated spreadsheet formula 510 to Python code 520. The reverse compiler system's user interface thus displays Python code 520 along with any other translated code (e.g., import statements) in its Python source code editor. The reverse compiler system may store information mapping code segments producing from parsing spreadsheet formula 510 and Python code 520. The reverse compiler system further can store mapping information between corresponding spreadsheet and Python code segments, as well as information indicating locations of arguments within source code.

In some embodiments, the user subsequently wants to modify Python code 520 and obtain a translation of the modified code into a spreadsheet program. The user can replace the first argument from “0” to “2,” so that the updated Python code reads “np.where(dfiloc[:,2]==df.iloc . . . ” in the Python source code editor (step 910). The reverse compiler system can detect that the only modified portion was an argument (step 920), so the affected Python code does not need to be fully remapped and retranslated (step 930). Instead, the reverse compiler system can proceed to revise the current spreadsheet 510 with the updated argument.

First, the reverse compiler system determines which block of spreadsheet code corresponds to the modified Python code (step 940). As described above, the reverse compiler system stores information indicating corresponding blocks of code between the spreadsheet program and the Python code. Based on the mapping, the reverse compiler system determines that the block including Python code 520 corresponds to the block of the spreadsheet program including spreadsheet formula 510. In some embodiments, the identified spreadsheet block is identified by a block index (e.g., “Block 2” at index 2). Other indexing methods or schemes can be utilized as long as the blocks are separately identifiable.

The reverse compiler system then determines which argument in the Python code was modified (step 950). The reverse compiler system may determine that the modified argument was the first argument in Python code 520 (i.e., the argument to the first “iloc” function). The reverse compiler system may store information indication the location at which the argument is positioned in Python code 520 (e.g., at byte location “a”).

The reverse compiler system may determine to which argument in spreadsheet formula 510 the first argument in Python code 520 corresponds (step 960). The reverse compiler system may make this determination based on the mapping information stored between corresponding arguments in spreadsheet formula 510 and Python code 520. Here, the reverse compiler system can determine that the first argument in Python code 520 corresponds to the first argument in spreadsheet formula 510, which has value “A:A” and located at position 3 to 5 in spreadsheet formula 510.

The reverse compiler system may revise the identified first argument in the spreadsheet formula 510 and rebuilds the updated spreadsheet program (step 970). First, the reverse compiler system can determine the equivalent value of modified value “2” of the first argument in Python code 520 in the spreadsheet formula. The reverse compiler system can look up the equivalent value of calling a column index “2” in spreadsheet formula notation (e.g., spreadsheet formula A1 notation), which returns value “C:C.” Since the first argument in spreadsheet formula 510 is located at position 305, the reverse compiler system revises the first argument to have value “C:C.” The reverse compiler system can then rebuild the updated spreadsheet program including the revising formula “IF(C:C=B:B,0,IF(A:A>B:B,1,−1)).”

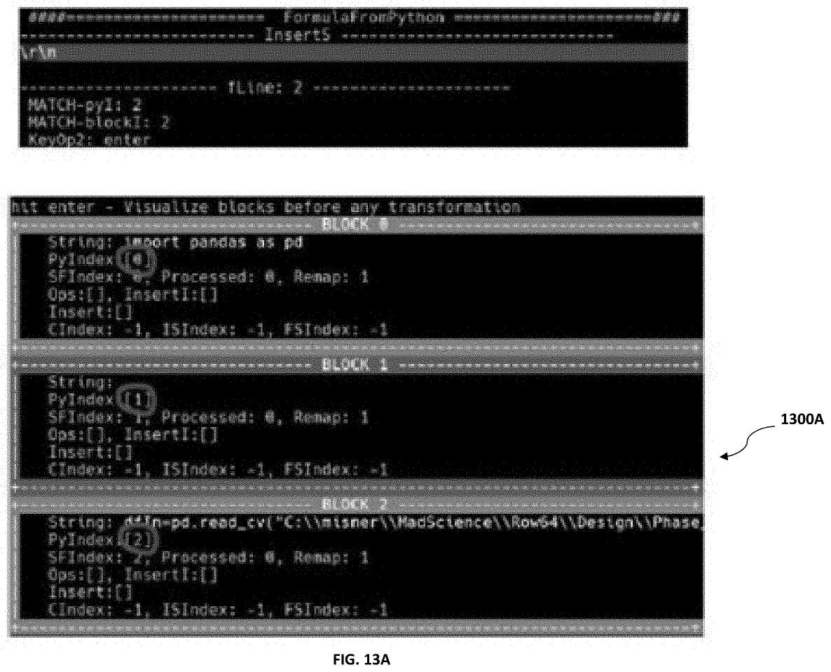

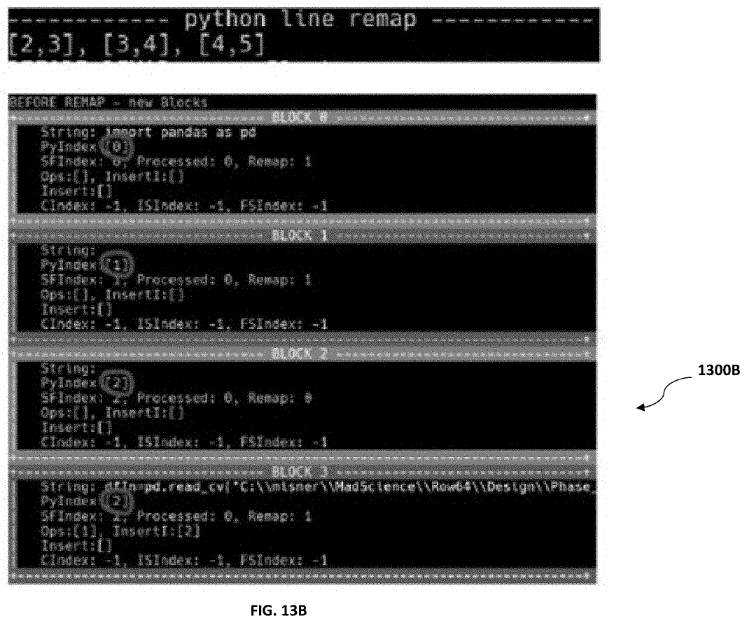

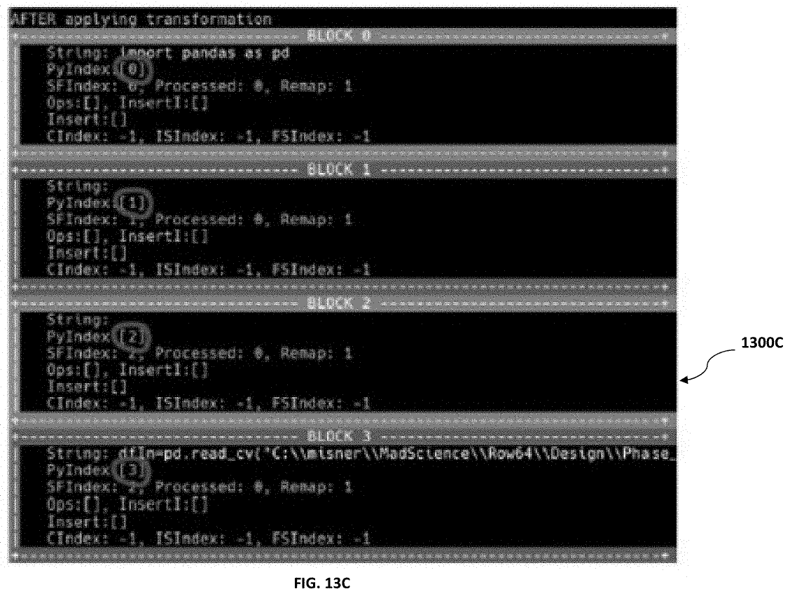

Additional mapping capabilities of the reverse compiler system are described below. In addition to mapping changes in source code, the reverse compiler system can also map changes caused by other keystrokes, such as the “enter” key and “delete” key. For example, mapping 1200 of FIG. 12 shows an example of blocks mapped to blank lines in the source code (e.g., created by pressing the “enter” key). As another example, FIG. 13 provides an exemplary remapping 1300 performed by the reverse compiler system. When the user hits the “enter” key in the reverse compiler system's source code editor, the reverse compiler system mat add a new blank line created by the enter keystroke as a new code block. Due to the generation of an additional code block, the reverse compiler system may remap the blocks with appropriate indices, so that each block of code is separately identifiable.

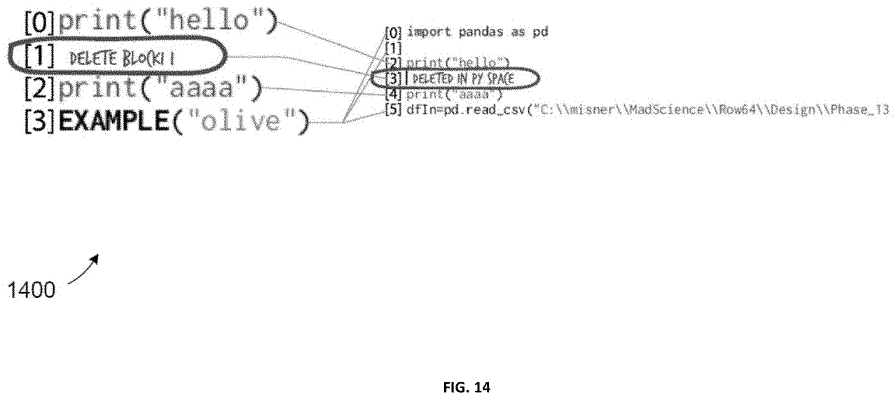

FIG. 14 provides an exemplary mapping 1400 of a deletion processed by the reverse compiler system. For instance, when the user hits the “delete” key in a blank line in the reverse compiler system's source code editor, the reverse compiler system can delete the blank line and its corresponding block. Due to the deletion of a code block, the reverse compiler system may remap the blocks with appropriate indices.

Embodiments described herein are performed by suitable computer systems. The user device (e.g., laptop, computer, tablet device, etc.) that a user uses to interact with the graphical user interface of the reverse compiler system stores mapping information by local and/or remote data storage means. In some embodiments, the user device establishes a network communication with a server to perform methodologies or modules discussed herein.

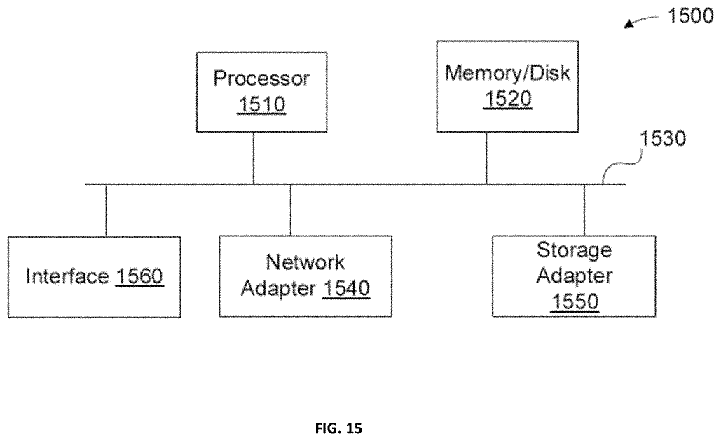

FIG. 15 is a diagrammatic representation of a machine in the example form of a computer system 1500 within which a set of instructions, for causing the machine to perform any one or more of the methodologies or modules discussed herein, may be executed.

The computer system 1500 includes a processor 1510, memory and non-volatile memory 1520, a communications BUS 1530, a network adapter 1540, a disk interface 1550 and an interface device 1560. Various common components (e.g., cache memory) are omitted for illustrative simplicity. The computer system 1500 is intended to illustrate a hardware device on which any of the components described in the examples (and any other components described in this specification) can be implemented. The components of the computer system 1500 are coupled together via the bus 1530 or through some other known or convenient device.

This disclosure contemplates the computer system 1500 taking any suitable physical form. As an example, and not by way of limitation, a computer system 1500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1500 may include one or more computer systems 1500; be unitary or distributed; span multiple locations; span multiple machines; or reside in a cloud, which may include one or more cloud components in one or more networks. Where appropriate, one or more computer systems 1500 may perform, without substantial spatial or temporal limitation, one or more steps of one or more methods described or illustrated herein. As an example, and not by way of limitation, one or more computer systems 1500 may perform in real time or in batch mode one or more steps of one or more methods described or illustrated herein. One or more computer systems 1500 may perform at different times or at different locations one or more steps of one or more methods, described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM), static RAM (SRAM), and video RAM (VRAM). The memory can be local, remote, or distributed.

The bus also couples the processor to the non-volatile memory and drive unit. The non-volatile memory is often a solid state drive (SSD), magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1500. The non-volatile storage can be local, remote, or distributed. The non-volatile memory is optional because systems can be created with all applicable data available in memory. A typical computer system will usually include, at least, a processor, memory, and a device (e.g., a bus) coupling the memory to the processor.

Software is typically stored in the non-volatile memory and/or the drive unit. Indeed, storing an entire large program in memory may not even be possible. Nevertheless, it should be understood that for software to run, if necessary, it is moved to a computer readable location appropriate for processing, and for illustrative purposes, that location is referred to as the memory. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1500. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted reside in the interface.

In operation, the computer system 1500 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system, and its associated file management system. The file management system is typically stored in the non-volatile memory and/or drive unit and causes the processor to execute the various acts required by the operating system to input and output data and to store data in the memory, including storing files on the non-volatile memory and/or drive unit.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a stand-alone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine, and that cause the machine to perform any one or more of the methodologies or modules of the presently disclosed technique and innovation.

In general, the routines executed to implement the embodiments of the disclosure may be implemented as part of an operating system or a specific application, component, program, object, module or sequence of instructions, referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Further examples of machine-readable storage media, machine-readable media, or computer-readable (storage) media include, but are not limited to, recordable-type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission-type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation; rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application” or “app”) may include one or more modules, or a module may include one or more application programs.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully-functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

The present techniques will be better understood with reference to the following enumerated embodiments:

1. A method comprising: receiving first code written in a first programming language; generating second code written in a second programming language, the second code being functionally equivalent to the first code; detecting a modification to the second code; and updating the first code based on the detected modification.
2. The method of embodiment 1, wherein updating the first code comprises: updating the first code in real-time; and causing the updated first code to be displayed within a user interface.
3. The method of any one of embodiments 1-2, wherein detecting the modification comprises: detecting a user interaction with a user interface rendering the first code.
4. The method of any one of embodiments 1-3, wherein receiving the first code comprises: receiving at least one keyboard shortcut for entering at least one of a preset formula or a preset function, the at least one keyboard shortcut being a keyboard shortcut in the first programming language.
5. The method of any one of embodiments 1-4, wherein generating the second code comprises: performing a lexical analysis to the first code, including tokenizing the first code to produce a list of tokens.
6. The method of embodiment 5, wherein the first code is represented by a string of characters, tokenizing the first code comprises: splitting the string of first code into units having assigned meanings.
7. The method of embodiment 6, wherein the units having the assigned meanings include at least one of: a separator, an operator, a keyword, a literal, or an identifier.
8. The method of any one of embodiments 5-6 further comprising: upon determining that the lexical analysis has completed, performing a parsing analysis, including loading the list of tokens into one or more data structures for compiling.
9. The method of embodiment 8, wherein performing the parsing analysis comprises: transforming the list of tokens into an abstract syntax tree to represent a structure of the first code.
10. The method of any one of embodiments 5-9, further comprising: determining, from the list of tokens, a value and an assigned meaning of each token.
11. The method of embodiment 10, further comprising: determining, based on the value and the assigned meaning of each token, one or more segments of the first code that correspond to a formula or function, and one or more characters in the first code corresponding to an argument.
12. The method of embodiment 11, further comprising: determining, for each of the code segments of the first code, functionally equivalent code segments in the second code.
13. The method of embodiment 12, wherein determining the functionally equivalent code segments comprises: retrieving a preconfigured mapping of formulas, functions, operators, and arguments written in the first programming language to formulas, functions, operators, and arguments written in the second programming language.
14. The method of embodiment 13, wherein retrieving the preconfigured mapping comprises: determining the first programming language; determining the second programming language; and selecting the preconfigured mapping from a plurality of preconfigured mappings based the first code being written in the first programming language and the second code being written in the second programming language.
15. The method of any one of embodiments 13-14, wherein generating the second code comprises: generating a mapping indicating a position of each argument included in the first code and a position that each argument is to be inserted into the second code.
16. The method of embodiment 15, wherein the position that each argument is to be inserted into the second code comprises a byte location at which the argument is to be inserted into a corresponding segment of the second code.
17. The method of any one of embodiments 1-16, further comprising: determining a portion of the second code associated with the modification; and determining whether the portion of the second code is within an argument.
18. The method of embodiment 17, wherein the modification comprises at least one of: adding a line of code including a function to the second code, deleting a line of code from the second code, or modifying a function included in the second code.
19. The method of embodiment 18, wherein the modification modifies the function included in the second code, the method further comprises: determining one or more blocks of code from the first code affected by the modification to the function included in the second code.
20. The method of embodiment 19, wherein updating the first code comprises: identifying, based on the one or more blocks, one or more lines of code from the second code that were modified; determining one or more lines of code from the first code that are to be updated based on the one or more lines of code from the second code that were modified; and generating the updated first code comprising updates to at least some of the one or more lines of code from the first code based on the one or more modified lines of the second code.
21. The method of any one of embodiments 17-21, wherein the portion of the second code is within the argument, updating the first code comprises: determining a portion of the first code that is affected by the portion of the second code that is modified; determining an argument within the portion of the second code that was modified; determining an argument within the portion of the first code that corresponds to the argument within the portion of the second code that was modified; revising the argument within the portion of the first code to match a value of the modified argument within the portion of the second code; and rebuilding the first code based on the revised argument within the portion of the first code.
22. The method of any one of embodiments 1-21, further comprising: determining a portion of the second code associated with the modification; determining a portion of the first code related to the portion of the second code; and storing or updating information indicating a correspondence between the portion of the second code and the portion of the first code.
23. The method of any one of embodiments 1-22, further comprising: detecting an invocation to cause an existing line from the first code or the second code to be deleted; removing the existing line from the first code or the second code; and causing a mapping of the first code and the second code to be updated based on the removed existing line.
24. The method of any one of embodiments 1-24, wherein the first code is displayed within a first area of a user interface (UI) and the second code is displayed within a second area of the UI.
25. The method of embodiment 24, wherein the first area is a first code editor for editing code in the first programming language and the second area is a second code editor for editing code in the second programming language.
26. The method of any one of embodiments 1-25, wherein the first code comprises a spreadsheet formula.
27. The method of any one of embodiments 1-26, further comprising: generating a plot based on the spreadsheet formula by executing the first code or the second code.
28. The method of embodiment 27, wherein: the first code is displayed within a first area of a user interface (UI); the second code is displayed within a second area of the UI; and the plot is displayed in a third area of the UI.
29. The method of any one of embodiments 1-28, wherein the functionally equivalent code segments are determined based on a preconfigured mapping stored as a lookup table.
30. The method of embodiment 29, wherein the preconfigured mapping is generated based on prior translations performed by the code translation engine between code written in the first programming language and code written in the second programming language.
31. The method of any one of embodiments 29-30, wherein the functionally equivalent code segments are determined based on a preconfigured mapping stored as a lookup table.
32. The method of any one of embodiments 1-31, wherein generating the second code comprises: retrieving a preconfigured mapping of arguments written in the first programming language to arguments written in the second programming language; identifying, within the first code, based on the preconfigured mapping, one or more of the arguments written in the first programming language included in the first code; and determining, for each of the one or more the arguments written in the first programming language, based on the preconfigured mapping, a corresponding argument of the arguments written in the second programming language included in the second code.
33. The method of embodiment 32, wherein the preconfigured mapping includes a first rule for translating an argument written in the first programming language to an argument written in the second programming language, and a second rule for translating at least one of an operator or a function written in the first programming language into at least one of an operator or a function written in the second programming language.
34. The method of any one of embodiments 1-33, wherein the second code being functionally equivalent to the first code comprises an output produced by executing the first code being equivalent to an output produced by executing the second code.
35. The method of any one of embodiments 1-34, wherein the code translation engine performs lexical analysis and syntactic analysis of the first code.
36. The method of any one of embodiments 1-35, wherein the modification comprises an edit to the second code, detecting the modification comprises: detecting a notification to initiate a translation process to cause the first code to be updated based on the edit to the second code.
37. The method of embodiment 36, wherein the first code and the second code are displayed within a user interface (UI), the UI comprises at least one button that is invoked to cause the notification to be generated.
38. The method of any one of embodiments 1-37, further comprising: storing information indicating a correspondence between a portion of the second code associated with the modification and a portion of the first code related to the portion of the second code, wherein the information identifies a start and an end of the portion of the second code and a start and end of the portion of the first code.
39. The method of embodiment 38, wherein the information includes at least one of: a line number, an index, or source code text associated with at least one of the portion of the first code or the portion of the second code.
40. The method of any one of embodiments 1-39, further comprising: detecting changes to the first code or the second code caused by keystrokes; and updating a mapping of correspondences between the first code and the second code based on the detected changes.
41. The method of any one of embodiments 1-40, further comprising: detecting an invocation to cause a new line to be added to the first code or the second code; adding a blank line to the first code or the second code based on the detected invocation; and causing a mapping of the first code and the second code to be updated based on the added blank line.
42. The method of embodiment 41, wherein the mapping includes indications of a location of each block of code within the first code and each block of code within the second code, and the updated mapping stores an updated location of each block of code within the first code and each block of code within the second code based on the detected invocation.
43. The method of any one of embodiments 1-42, wherein the first code is received using a code translation engine, the second code is generated using the code translation engine, the modification to the second code is detected using the code translation engine, and the first code is updated using the code translation engine.
44. A system, comprising: one or more processors programmed to perform the method of any one of embodiments 1-43.
45. A non-transitory computer-readable medium storing computer program instructions that, when executed by one or more processors, effectuate operations comprising the method of any one of embodiments 1-43.
46. A code translation engine comprising one or more processors programmed to perform the method of any one of embodiments 1-43.

What is claimed is:

1. A computer-implemented method comprising:
receiving, using a code translation engine, first code written in a first programming language;
generating, using the code translation engine, second code written in a second programming language, the second code being functionally equivalent to the first code;
detecting, using the code translation engine, a modification to the second code; and
updating, using the code translation engine, the first code based on the detected modification.

2. The method of claim 1, wherein updating the first code comprises:
updating the first code in real-time; and
causing the updated first code to be displayed within a user interface.

3. The method of claim 1, wherein detecting the modification comprises:
detecting a user interaction with a user interface rendering the first code.

4. The method of claim 1, wherein receiving the first code comprises:
receiving at least one keyboard shortcut for entering at least one of a preset formula or a preset function, the at least one keyboard shortcut being a keyboard shortcut in the first programming language.

5. The method of claim 1, wherein generating the second code comprises:
performing a lexical analysis to the first code, including tokenizing the first code to produce a list of tokens.

6. The method of claim 5, wherein the first code is represented by a string of characters, tokenizing the first code comprises:
splitting the string of first code into units having assigned meanings.

7. The method of claim 5, further comprising:
upon determining that the lexical analysis has completed, performing a parsing analysis, including loading the list of tokens into one or more data structures for compiling.

8. The method of claim 7, performing the parsing analysis comprises:
transforming the list of tokens into an abstract syntax tree to represent a structure of the first code.

9. The method of claim 5, further comprising:
determining, from the list of tokens, a value and an assigned meaning of each token.

10. The method of claim 9, further comprising:
determining, based on the value and the assigned meaning of each token, one or more segments of the first code that correspond to a formula or function, and one or more characters in the first code corresponding to an argument.

11. The method of claim 10, further comprising:
determining, for each of the code segments of the first code, functionally equivalent code segments in the second code.

12. The method of claim 11, wherein determining the functionally equivalent code segments comprises:
retrieving a preconfigured mapping of formulas, functions, operators, and arguments written in the first programming language to formulas, functions, operators, and arguments written in the second programming language.

13. The method of claim 12, wherein retrieving the preconfigured mapping comprises:
determining the first programming language;
determining the second programming language; and
selecting the preconfigured mapping from a plurality of preconfigured mappings based the first code being written in the first programming language and the second code being written in the second programming language.

14. The method of claim 12, wherein generating the second code comprises:
generating a mapping indicating a position of each argument included in the first code and a position that each argument is to be inserted into the second code.

15. The method of claim 1, further comprising:
determining a portion of the second code associated with the modification; and
determining whether the portion of the second code is within an argument.

16. The method of claim 15, wherein the modification comprises at least one of: adding a line of code including a function to the second code, deleting a line of code from the second code, or modifying a function included in the second code, and wherein the modification modifies the function included in the second code, the method further comprises:
determining one or more blocks of code from the first code affected by the modification to the function included in the second code.

17. The method of claim 16, wherein updating the first code comprises:
identifying, based on the one or more blocks, one or more lines of code from the second code that were modified;
determining one or more lines of code from the first code that are to be updated based on the one or more lines of code from the second code that were modified; and
generating the updated first code comprising updates to at least some of the one or more lines of code from the first code based on the one or more modified lines of the second code.

18. The method of claim 15, wherein the portion of the second code is within the argument, updating the first code comprises:
determining a portion of the first code that is affected by the portion of the second code that is modified;
determining an argument within the portion of the second code that was modified;
determining an argument within the portion of the first code that corresponds to the argument within the portion of the second code that was modified;
revising the argument within the portion of the first code to match a value of the modified argument within the portion of the second code; and
rebuilding the first code based on the revised argument within the portion of the first code.

19. A system, comprising:
one or more processors programmed to:
receive first code written in a first programming language;
generate second code written in a second programming language, the second code being functionally equivalent to the first code;
detect a modification to the second code; and
update the first code based on the detected modification.

20. A non-transitory computer-readable medium storing computer program instructions that, when executed by one or more processors, effectuate operations comprising:
receiving, using a code translation engine, first code written in a first programming language;
generating, using the code translation engine, second code written in a second programming language, the second code being functionally equivalent to the first code;
detecting, using the code translation engine, a modification to the second code; and
updating, using the code translation engine, the first code based on the detected modification.
